(19) United States
(12) Patent Application Publication
(10) Pub. No.: US 2021/0047829 A1
(43) Pub. Date: Feb. 18, 2021

(54) Clip for Support Relative to Studs

(71) Applicant: ERICO INTERNATIONAL CORPORATION, Solon, OH (US)

(72) Inventor: Scott Ernest Anderson, Garrettsville, OH (US)

(21) Appl. No.: 16/992,366

(22) Filed: Aug. 13, 2020

Related U.S. Application Data
(60) Provisional application No. 62/886,757, filed on Aug. 14, 2019.

(51) Int. Cl. E04B 1/41; E04B 1/58; F16B 7/04

(52) U.S. Cl. CPC E04B 1/40; E04B 2001/405; F16B 7/0493; E04B 1/58

(57) ABSTRACT

A support device for supporting a support member relative to a building structure can include a support body with a support-body opening that is sized to receive the support member. A first finger can extend into alignment with the support-body opening to secure the support member within the support-body opening. A first extension can be configured to move relative to at least part of the support body to move the first finger. Moving the first extension can move the first finger to release the support member to slide within the support-body opening.

### CROSS-REFERENCE TO RELATED APPLICATIONS

This application claims priority to U.S. Provisional Patent Application No. 62/886,757, filed on Aug. 14, 2019 and titled Clip for Support Relative to Studs, the entirety of which is incorporated herein by reference.

### BACKGROUND

It may be useful to support various devices between studs or other building supports. For example, when electrical junction boxes are mounted inside walls, building codes may specify requirements for support of cables or other electrical conductors that extend from the boxes, sometimes referred to as a first means of support. Accordingly, it can be useful to provide structural members that extend between studs, in general alignment with electrical boxes, to support devices that in turn provide support for cables. In other contexts, support of other devices or objects, including pipes or other conduits, may also be usefully provided by support members that extend between adjacent studs.

### SUMMARY

Some embodiments of the invention provide a support device to support a support member between a first stud with a first stud opening and a second stud with a second stud opening. A stud-attachment portion can include a first arm and a second arm, the first and second arms being configured to collectively secure the support device to either of the first or second stud openings. A support body can be connected to the stud-attachment portion and can include a support-body opening, first and second fingers, and first and second extensions. The support-body opening can be sized to receive the support member. The first and second fingers can extend from first and second opposing sides of the support-body opening and being movable between: an engaged orientation in which the first or second fingers define a first clearance therebetween, to secure the support member within the support-body opening; and a released orientation, in which first and second fingers define a second clearance therebetween, larger than the first clearance, to release the support member to be withdrawn from the support-body opening. The first and second extensions can be configured to be moved towards each other, to flex the support body and move the first and second fingers from the engaged orientation to the released orientation.

Some embodiments of the invention provide support arrangement to secure a support member between a first stud with a first stud opening and a second stud with a second stud opening. First and second support devices can be substantially identical to each other, and can each include a clip portion and a support body. The clip can be configured to engage either of the first or second studs at the first or second stud openings. The support body can include a support-body opening that is configured to receive the support member therethrough, at least one finger extending into alignment with the support-body opening to secure the support member within the support-body opening, and an extension that is movable to move the at least one finger to release the support member. The first and second support devices can be configured to receive and secure a respective end of the support member and to clip to a respective one of the first or second studs to support the support member between the first and second studs.

Some embodiments of the invention provide a support device to support a support member relative to a building structure. An attachment portion can be configured to secure the support device to the building structure. A support body can be connected to the attachment portion. The support body can include a support-body opening that is sized to receive the support member, a first finger that extends into alignment with the support-body opening to engage the support member to secure the support member within the opening, and a first extension that is configured to move relative to at least part of the support body to move the first finger and thereby release the support member to slide within the opening.

Some embodiments of the invention provide a clip to secure a support member relative to a first stud or a second stud. A support body can include a support body opening sized to receive the support member, first and second extensions that extend away from the support body opening, and first and second fingers that extend from first and second opposing sides of the support-body opening, respectively, at least partly across the support body opening. The first and second extensions can be configured to be urged towards each other by an applied force to flex the support body and thereby move the first and second fingers from an engaged orientation to a released orientation, the first and second extensions being configured to resiliently move away from each other when the applied force is released to return the first and second fingers toward the engaged orientation. The first and second fingers, in the engaged orientation, can define a first clearance therebetween to secure the support member within the support-body opening. The first and second fingers, in the released orientation, can define a second clearance therebetween, larger than the first clearance, to release the support member to be withdrawn from the support-body opening.

Some embodiments of the invention provide a support arrangement to secure a support member between a first stud and a second stud. First and second support devices can be substantially identical to each other and can include: support body, and a clip portion that is configured to engage either of the first or second studs. Each of the support bodies can include: a support-body opening that is closed on four sides and is configured to receive the support member therethrough; at least one finger extending into alignment with the support-body opening to resiliently secure the support member within the support-body opening; and at least one extension that is resiliently movable to move the at least one finger to release the support member. Each of the first and second support devices can be configured to receive and secure a respective end of the support member via the support-body opening and the at least one finger, and to be clipped to a respective one of the first or second studs via the clip portion, to support the support member between the first and second studs.

Some embodiments of the invention can include a support device to support a support member relative to a building structure. A support body can include a support-body opening, a first finger, and first and second extensions. The support-body opening can be sized to receive the support member. The first finger can extend into alignment with the support-body opening to resiliently engage the support member to secure the support member within the support-body opening. The first and second extensions can be configured to be squeezed toward each other to move the first finger and thereby release the support member to slide within the support-body opening.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIGS. 1 and 2 are isometric views of a stud spanner arrangement according to an embodiment of the invention, as installed and in isolation, respectively, including support devices according to an embodiment of the invention;

FIG. 3 is an enlarged isometric view of the stud spanner arrangement of FIGS. 1 and 2, including one of the support devices;

FIG. 4 includes front elevation and enlarged front elevation views of one of the support devices of FIGS. 1 and 2;

FIG. 5 includes isometric views of the support devices of FIGS. 1 and 2 as installed on respective studs;

FIGS. 6A through 8B are front elevation partial views of one of the support devices of FIGS. 1 and 2 engaged with a variety of support bars; and

FIG. 9 is a side elevation view of the stud spanner arrangement installed in a non-horizontal configuration, according to an embodiment of the invention.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to the embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Unless specified or limited otherwise, the terms “mounted,” “connected,” “supported,” and “coupled” and the like are used broadly and encompass both direct and indirect mountings, connections, supports, couplings, and so on. Further, “connected” and “coupled” and the like are not restricted to physical or mechanical connections or couplings.

As used herein, unless otherwise specified or limited, reference to particular directions such as “horizontal” or “vertical” are generally made with respect to particular figures or other example reference frames, but are not necessarily descriptive of absolute orientations. Accordingly, a “vertical” (or other) feature relative to gravity in an example arrangement may not necessarily be oriented similarly in another arrangement. Also as used herein, unless otherwise specified or limited, “substantially identical” is used to indicate components or assemblies that are formed according to the same specifications (e.g., with regard to dimensions, tolerances, materials, and manufacturing techniques), such that variation between the components or assemblies falls within conventionally acceptable variation between instances of the particular type of manufactured parts.

Some embodiments of the invention are discussed below with respect to arrangements for conventional half-open building studs, such as conventional pre-fabricated steel studs. However, some embodiments can be usefully installed relative to a variety of other studs. Further, some embodiments can be used to support objects or devices relative to a variety of other building structures.

As noted above, it may be useful to secure devices (e.g., first means of support) relative to building support structures, such as wall studs. In some conventional arrangements, devices such as paired washers and wire-form shapes can be used to secure round rods between conventional building studs. For example, a first end of a round rod can be formed into a convolute shape (e.g., similar in profile to conventional paper clips) that can be attached at an opening on a first stud. A set of washers can be fitted onto a second end of the rod opposite the convolute shape, and the second end of the rod can be nested into an opening on a second stud. The washers can then be slid into place on opposite sides of the second stud, at the opening, to partially secure the rod in place on the stud.

Although this approach and other conventional approaches can generally support rods between studs, thereby to support other objects, certain issues may arise. For example, many conventional designs fail to securely engage a relevant stud to secure a rod, and are either not configured to secure a rod against sliding or are configured to grip a rod so tightly as to prevent useful slidable adjustment of the rod. This may complicate installation and reduce flexibility across different applications. As a further example, the relatively rigid nature of convolute wire-form attachment configurations (or other similar arrangements), particularly when integrally formed with a rod to be supported, can inhibit installation of the rod or other relevant support member between mounting locations that are not horizontally aligned. This may result in substantially reduced functionality, as mounting holes on sets of studs to mount between-stud supports are often formed at different respective heights on the studs, such as may require a support member that extends between the openings to extend non-horizontally between support devices that secure the support member to the studs.

As still another deficiency of some conventional designs, it may not be possible to readily use with any one particular support device with support members having different cross-sectional profiles or sizes. For example, designs that employ washer pairs or other similar arrangements may be limited to use with only a single size and shape of rod (e.g., circular rods of a certain diameter).

Embodiments of the invention can provide improved devices and associated arrangements for between-stud supports, including as may address some or all of the issues noted above. In some embodiments, for example, a support device to secure a support member (e.g., a rigid rod) to a stud can be configured to be easily (e.g., manually) moved between engaged and released orientations, as may respectively secure the support member against sliding and allow the support member to slide, relative to the support device. Thus, for example, such a support device can be easily adjusted to a desired location on the support member, then secured against sliding in order to retain the support member in a fixed location relative to the associated stud. Further, in some embodiments, a set (e.g., identical pair) of such support devices can be used on opposite ends of a support member in order to secure the support member to and between opposing studs that exhibit any variety of relative orientations.

In some embodiments, a support device can include a support body that defines an opening to slidably receive a support member (e.g., a square, round, rectangular, or other rod). One or more fingers of the support device can extend into alignment with the opening, i.e., can be disposed to extend directly into or to extend into a projected area of the opening relative to an insertion direction of the relevant support member, such as by angling inwardly from a side wall of the opening or other feature of the support body. The one or more fingers can be configured to be moved between an engaged orientation, in which the one or more fingers secure the support member against sliding or other movement within the opening, and a released orientation, in which the one or more fingers are spaced farther apart from each other than in the engaged orientation (i.e., provide a larger clearance), to allow the support member to slide within and, as appropriate, out of the opening.

In some embodiments, one or more extensions of the support body can be disposed opposite the one or more fingers, and can be configured to be manually engaged (e.g., engaged by hand or with hand tools) in order to move the one or more fingers between the engaged and released orientations. In some embodiments, a set of extensions can be configured to be moved towards each other (e.g., pinched or otherwise squeezed together) in order to flex an associated support body and thereby pivot a set of fingers away from each other, thus moving the fingers from an engaged orientation to a released orientation.

In some embodiments, an opening in a support body of a support device and one or more fingers of a support device can be configured to accommodate support members with different geometries. For example, fingers of support devices can be configured to be biased towards a fully engaged orientation, and to be movable from the fully engaged orientation to a fully released orientation, so that the fingers can securely engage support members of different sizes and shapes at a variety of intermediate engaged orientations that are between the fully engaged and fully released orientations. As another example, non-planar profiles on distal (i.e., free) ends of some fingers can allow the fingers to securely and interchangeably engage support members of round, square, rectangular and other geometries. In some embodiments, certain non-planar or non-square profiles (e.g., partial hexagonal profiles) can allow for multiple contact points between a given finger and an associated support member. Similarly, openings of support devices that are configured to receive a support member to be engaged by associated fingers can be sized to receive a wide range of support-member sizes at a wide range of installation angles.

In some embodiments, an opening in a support body of a support device and one or more fingers of a support device can be configured to accommodate non-horizontal installation of support members, as may be required for non-aligned openings in opposing studs. For example, an opening of a support body can be configured to exhibit a vertical clearance that is larger than the height of a relevant support member, so that the support member can pass through the opening when angled away from horizontal (e.g., by 25 degrees or more). Correspondingly, in some cases, clearance provided by one or more associated fingers, when in an engaged configuration, can be smaller than the vertical clearance. This may, for example, allow the support member to extend through the opening and to be securely held by the one or more fingers, in a horizontal or a non-horizontal orientation. In this regard, it may also be useful, in some embodiments, to configure a support device with a stud-attachment member that is spaced apart from an associated support body, as may more flexibly accommodate a range of orientations for the relevant support member when the stud-engagement member engages a stud.

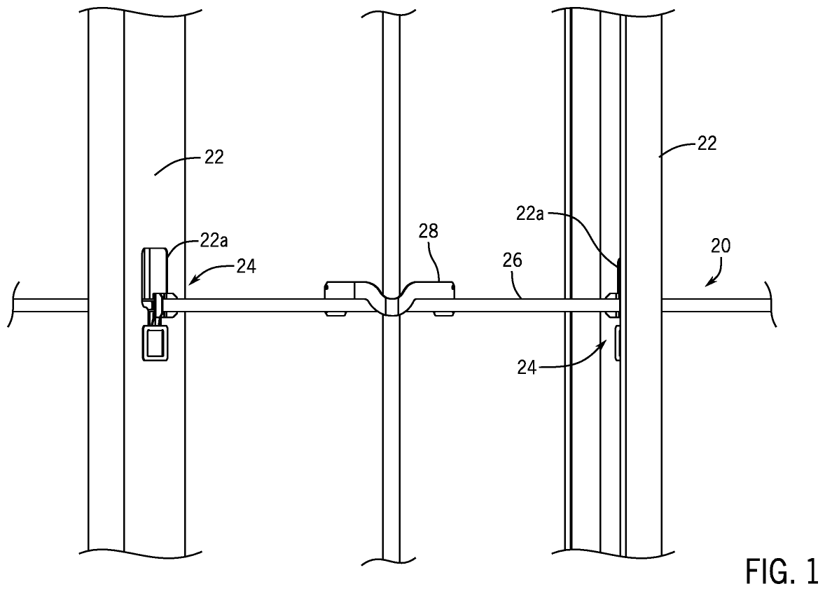

FIGS. 1 through 3 illustrate aspects of an example support arrangement 20 according to an embodiment of the invention, including as installed as a stud spanner between two conventional open-sided steel building studs 22 (see FIG. 1). In the embodiment illustrated, the support arrangement 20 includes a set of substantially identical support devices configured as support clips 24 that can receive, retain, and generally support a hollow rectangular rod 26. In particular, in the illustrated arrangement of FIG. 1, the support clips 24 engage the studs 22 at openings 22a therein, so that the rod 26 can be used to support other objects between the studs 22, including a pipe strap 28 as shown in FIG. 1, a first means of support (not shown), or other devices. In other embodiments or installations, however, other configurations are possible.

Usefully, each of the support clips 24 can be manually engaged to be moved between engaged and released configurations, as may allow the rod 26 to be secured or slid, respectively, relative to the support clips 24. In this way, for example, the support clips 24 can be readily installed onto the rod 26 at any desired position, and can thereby allow the rod to be customizably installed on any variety of stud (or other support-structure) configurations.

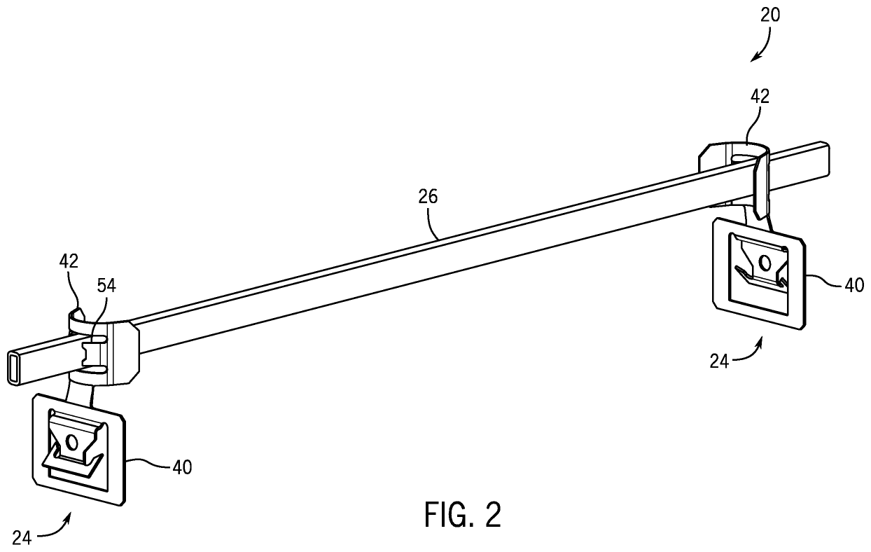

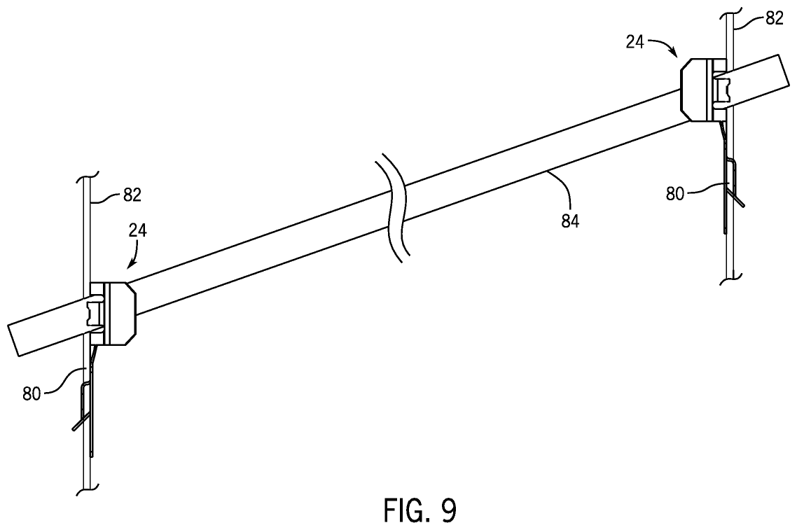

As with other installations discussed below, the configuration illustrated in FIGS. 1 and 2 is presented as an example only. For example, as also discussed below, the support clips 24 and other support devices disclosed herein can be used to secure support members of a wide range of configurations, including hollow and solid rods of square, rectangular, round (e.g., circular) and other configurations. Further, also as discussed below, support devices according to embodiments of the invention can be used to secure a support member in a wide variety of horizontal configurations (e.g., as in FIG. 1) and non-horizontal configurations (see, e.g., FIG. 9).

In the embodiment illustrated, each of the support clips 24 is formed as an integral spring steel stamping. This approach may allow for relatively inexpensive and reliable manufacturing, while providing appropriate elasticity for secure engagement of studs and support members. In other embodiments, however, other materials and methods of manufacture are possible.

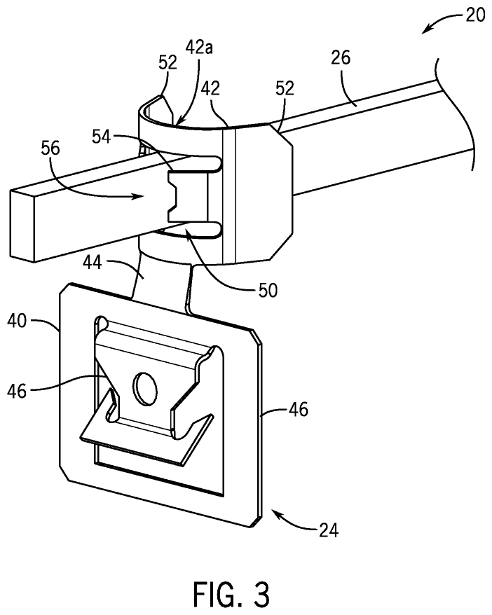

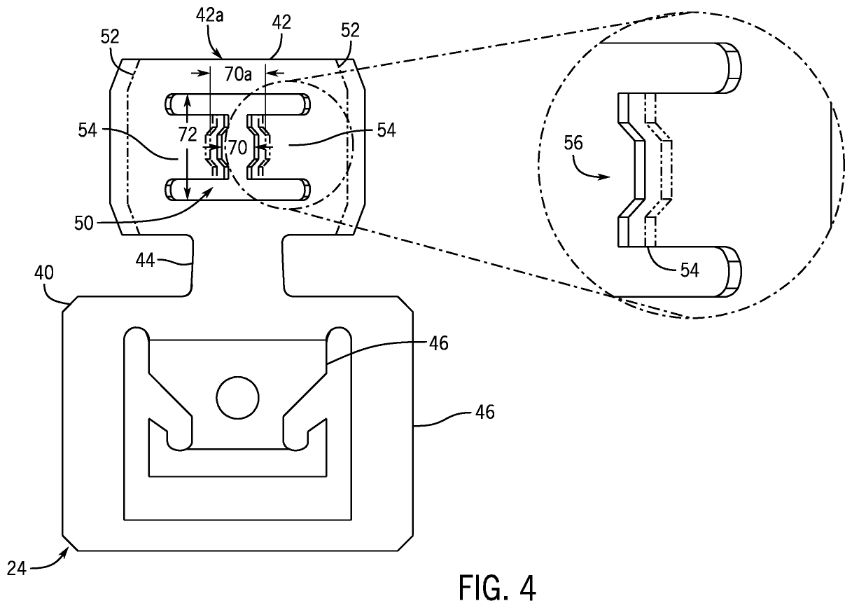

FIGS. 3 and 4 illustrate in enlarged detail certain additional aspects of the support clips 24, which may assist in secure engagement of a variety of support members (e.g., with different geometries), manually-operated slidable adjustment of support members, and secure installation of support members in non-horizontal orientations. Because the support arrangement 20 includes substantially identical configurations for both of the support clips 24, only one of the support clips 24 will be discussed below. Use of substantially identical support devices can be useful, for example, to reduce inventory burdens and simplify installation and adjustment procedures. In some embodiments, however, non-identical attachment devices (e.g., different support clips) can be used.

Generally, a support device according to embodiments of the invention can include an attachment portion that is configured to attach the support device to the relevant building structure (e.g., a steel stud) and a support body that is configured to slidably receive and selectively secure and release the relevant support member (e.g., rod). In the embodiment illustrated, as shown in FIGS. 3 and 4 in particular, the support clip 24 includes a stud-attachment portion 40 that is configured to secure the support clip 24 to either of the studs 22 at the openings 22a, and a support body 42 that is connected to the stud-attachment portion 40 by an angled neck 44.

In different embodiments, different types of clip arrangements or other known arrangements can be used to secure a support device to a stud or other structure. In the illustrated embodiment, for example, the stud-attachment portion 40 includes first and second arms 46 that are configured to resiliently engage opposing sides of either of the studs 22 at the associated opening 22a. In other embodiments, other types of clips, non-clip attachment structures, separate fasteners, or other devices can be used. For example, some embodiments can be configured to be secured to a building structure with separate fasteners, to be secured to lips or other structures of standard studs, and so on.

In some embodiments of a support device, a connection between an attachment portion and a support body can be configured to improve ease of access to the support body, as may facilitate easier installation and adjustment of a support member. For example, due to the planar nature of the studs 22 at the openings 22a, and the arrangement of the arms 46, the stud-attachment portion 40 is configured to extend substantially vertically when installed on the studs 22. In contrast, as shown in FIG. 3 in particular, the neck 44 angles away from an attachment plane defined by the arms 46 (e.g., the vertical plane of the studs 22 at the openings 22a). Accordingly, the support body 42 is disposed out of alignment with (e.g., laterally offset from) the attachment plane. As noted above, this can allow users to more easily access the support body 42, including when the support clip 24 is installed in a recessed portion of a stud. In the illustrated embodiment, the neck 44 angles obliquely relative to the attachment plane and, in particular, at an angle of about 15° or less, although other configurations are possible.

The support body 42 is formed as a symmetrical component, with walls that fully surround the perimeter of an internal support-body opening 50. The walls of the support body 42 also extend into ear-like extensions 52 on opposing lateral sides of the support body 42 and the opening 50. In the illustrated embodiment, the extensions 52 are angled away from the neck 44 and the stud-attachment portion 40 and exhibit chamfered corners for ease of engagement, although other configurations are possible. For example, some configurations may include vertically-extending or other tabs to facilitate easy engagement by a user. The support-body opening 50 and the extensions 52, as also discussed below, are configured so that the support-body opening 50 can receive and retain support members that have a variety of shapes and sizes, without interference from the extensions 52.

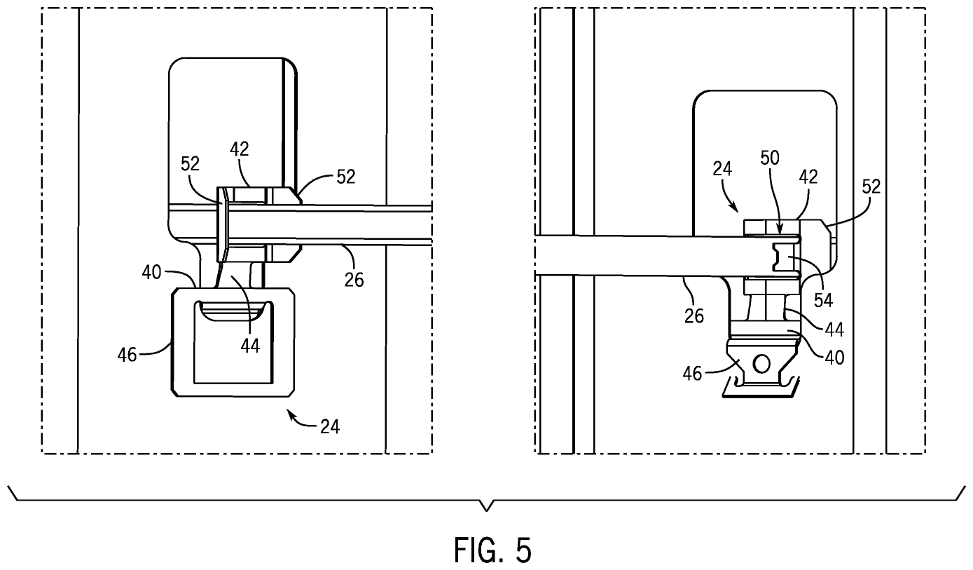

The support body 42 also includes first and second fingers 54 that extend into alignment with the support-body opening 50. In the illustrated embodiment, as shown in FIGS. 3 and 5 in particular, the fingers 54 do not extend in parallel with top and bottom walls of the support-body opening 50. Thus, the fingers 54 do not extend fully within the support-body opening 50, although the fingers 54 do extend generally in alignment with the opening 50, from the perspective of a support member (e.g., the rod 26) that extends therethrough (i.e., extend into a projection of the opening 50 along the direction of the support member).

In some embodiments, an angled configuration, including as shown for the fingers 54, may allow for easier installation of a support member and more secure engagement of a support member following installation. For example, the angled configuration shown for the support clip 24 places the fingers 54 in alignment with, but extending away from the opening 50 and the remainder of the support body 42. This configuration can dispose the fingers 54 to be flexed laterally outwardly by a “stabbing” installation of the rod 26 through the opening 50 (e.g., from right to left as in FIG. 3) more easily than if the fingers 54 extended directly towards each other (e.g., directly into the opening 50, fully in parallel with the remainder of the support body 42). Further, as force is applied to withdraw the rod 26 in the opposite direction, engagement of the rod 26 with the fingers 54 may draw the fingers 54 towards each other, thus increasing the retention force of the fingers 54 roughly in proportion with the force applied to the rod 26. In some embodiments, however, fingers may be aligned with and extend fully within a support-body opening, at least in some orientations (e.g., when in a fully engaged orientation), or can be otherwise configured.

In different embodiments, fingers can extend from different portions of a support body and can extend in different directions. For example, in the embodiment illustrated, the fingers 54 extend from opposing sides of the opening 50 generally towards, but not in parallel with, each other. Likewise, the fingers 54 extend along top and bottom sides of the support opening 50 and generally in parallel with those sides from a front view projection, as shown in FIG. 4. In other embodiments, however, other configurations are possible.

In the illustrated embodiment, the fingers 54 can be moved from an engaged orientation (e.g., as shown in solid lines in FIGS. 3 and 4) to a released orientation (e.g., as shown in dashed lines in FIG. 4), which exhibits a wider clearance between distal ends of the fingers 54, via manually engagement with the extensions 52. In particular, a user can use her fingers or hand tools to squeeze the extensions 52 together (i.e., towards each other) as shown in dashed lines in FIG. 4. Movement of the extensions 52 in this way can cause the top and bottom walls of the support body 42 to flex at the support-body opening 50 (e.g., along central member 42a, as shown in FIGS. 3 and 4), so that the fingers 54, which are anchored at lateral sides of the opening 50, pivot laterally outwardly. Thus, for example, by manually engaging the extensions 52, a user can easily move the fingers 54 from an engaged orientation, in which movement of the rod 26 is generally prevented, to a released orientation, in which the rod 26 can be relatively freely slid in either direction within the opening 50.

In the illustrated embodiment, the fingers 54 and the support body 42 in general are configured to move elastically, such that the fingers 54 are biased towards each other when moved from a fully engaged orientation towards a released orientation and will spring back towards the fully engaged orientation when the extensions 52 are released. In some embodiments, the fingers 54 can be configured to exhibit a bias towards each other over a range of orientations, including when engaged with a support member of particular (e.g., minimum rated) dimensions, so that the fingers 54 can securely grip support members of a range of sizes.

In some embodiments, only one finger may be provided, or multiple fingers having different profiles can be used. For example, whereas both of the fingers 54 are configured to move generally symmetrically to release a support member (as also discussed above), some embodiments can include only a single finger that is configured to move to release a support member. In some embodiments, a relatively rigid finger may extend from one side of a support body into alignment with a support-body opening, and a relatively flexible finger (e.g., similar to the fingers 54) can extend from a different side of the support body into alignment with the support-body opening.

Similarly, in some embodiments, only one extension may be provided, or only a single extension may be configured to be moved to move a corresponding finger. For example, features on a first side of a support device in some embodiments can be formed with thicker or wider material than features on an opposing second side of the support device. Accordingly, for example, it may be possible to manually move an extension and corresponding finger of the second side of the support device, but not an extension and corresponding finger (if any) of the first side.

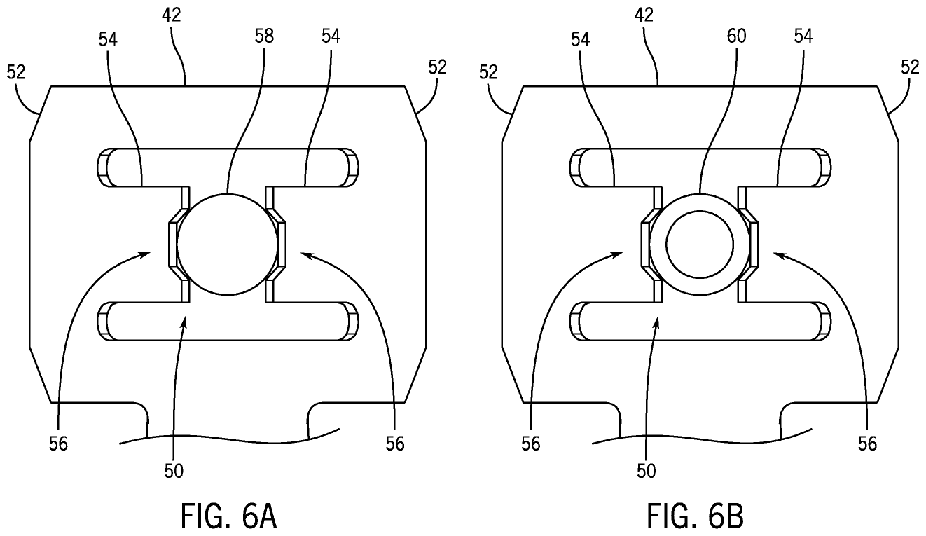

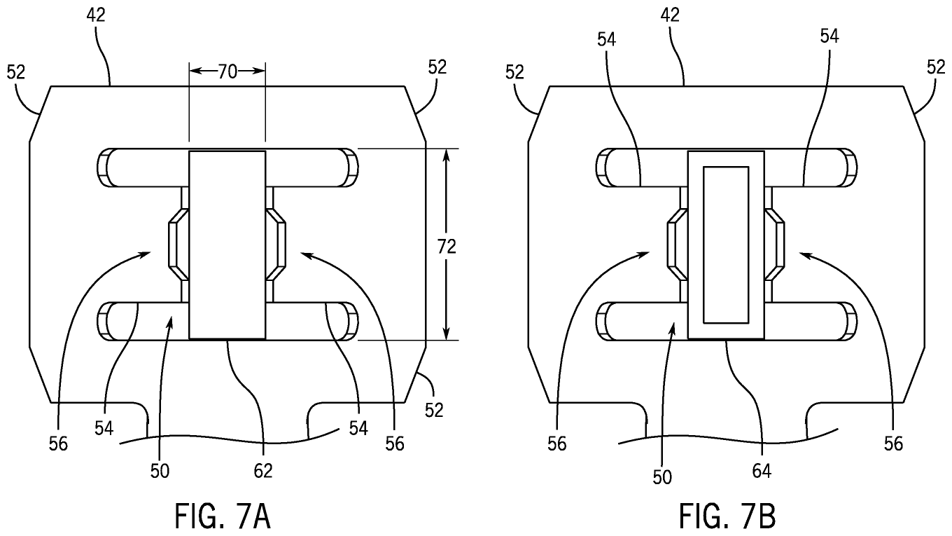

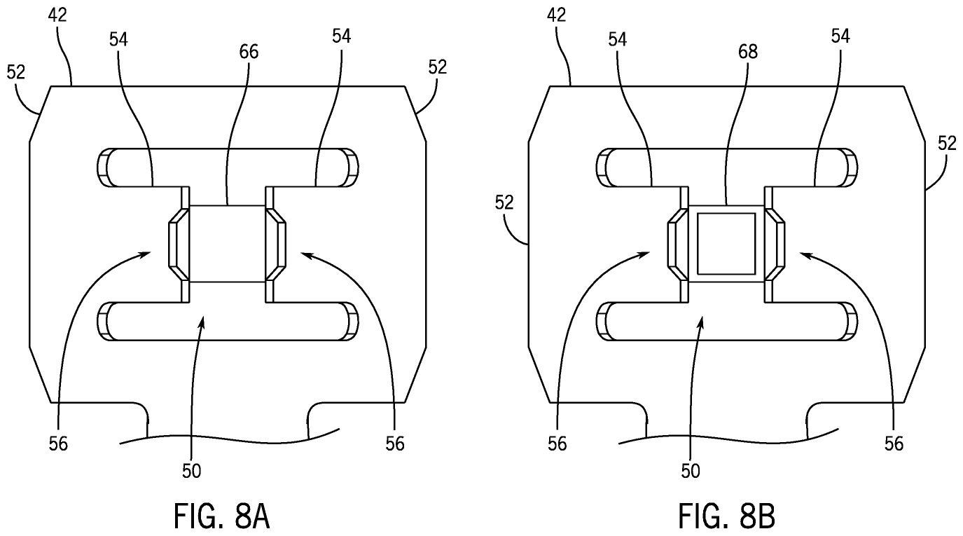

In some embodiments, non-planar profiles can be provided at distal ends of fingers in order to provide more secure engagement with a variety of support members. As illustrated in FIG. 4 in particular, for example, a part of the distal end of each of the fingers 54 exhibits three-sided (e.g., partial hexagonal) cut-outs 56. As illustrated in FIGS. 6 through 8, this arrangement can allow for relatively secure engagement with support members having a variety of profiles, including solid and hollow round rods 58, 60 (e.g., circular rods, as shown), solid and hollow non-square rectangular rods 62, 64, and solid and hollow square rods 66, 68. As illustrated in FIGS. 6A and 6B in particular, the three-sided configuration of the cut-outs 56 allow each of the fingers 54 to engage the round rods 58, 60 at three different points to provide a particular secure engagement. Further, as illustrated in FIGS. 7A through 8B, each of the fingers 54 can also provide at least two engagement points for the planar surfaces of the rectangular and square rods 62, 64, 66, 68. Although a three-sided cut-out can be particularly beneficial in some embodiments, other non-planar profiles are also possible, including circular or ovular cut-outs, toothed profiles, triangular or other polygonal profiles, and so on.

In some embodiments, the relative size of clearances provided by a support-body opening and one or more fingers can also provide flexibility relative to the types of support members that can be used. As illustrated in FIG. 7A in particular, for example, the fingers 54 define a first clearance 70 when in the engaged orientation, which is substantially smaller (e.g., half as small or smaller) than a second, transverse clearance 72 between top and bottom walls of the support-body opening 50. (In the illustrated embodiment, a first clearance 70a in the released orientation, as shown in FIG. 4, is also smaller than the clearance 72.) The relatively large clearance 72 can allow the support clip 24 to readily accommodate transversely (e.g., vertically) elongate support members, such as, for example, the rectangular rods 62, 64. And the relatively small clearance 70, in combination with the elastic flexibility of the fingers 54 (and the support body 42 in general) can allow the support clip 24 to also readily accommodate relatively small support members, such as the square rods 66, 68 (see FIGS. 8A and 8B).

A relatively large vertical clearance for a support-body opening can also provide other benefits, including for installations in which two or more cooperating support devices are to be installed at different heights from each other. As illustrated in FIG. 9, for example, openings 80 in support structures 82 may sometimes not be horizontally aligned (i.e., may be at different heights). With the support clips 24 installed at each of the openings 80, the relatively large size of the clearance 72 (see FIG. 7) can allow a support rod 84 to extend at a non-zero angle relative to horizontal, without interference from the solid walls of the support bodies 42 that surround the support-body openings 50 (not shown in FIG. 7). Further, the elastic engagement of the fingers 54 with the rod 84, as bolstered by the discrete-point contacts provided by the cut-outs 56, can help to ensure that the rod 84 remains in place as installed.

Thus, embodiments of the invention can provide an improved support device relative to conventional designs, including for providing first means of support for cables or other electrical connectors. In some embodiments, for example, support devices according to the invention can accommodate a wide range of sizes and shapes of support members and can provide useful support with the support members at horizontal or non-horizontal orientations. Further, some embodiments can be easily (e.g., manually) slidably adjusted relative to associated support members, without loss of gripping power on the support members once the adjustment has been completed.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A clip to secure a support member relative to a first stud or a second stud, the clip comprising:
a support body that includes a support body opening sized to receive the support member, first and second extensions that extend away from the support body opening, and first and second fingers that extend from first and second opposing sides of the support-body opening, respectively, at least partly across the support body opening;
the first and second extensions being configured to be urged towards each other by an applied force to flex the support body and thereby move the first and second fingers from an engaged orientation to a released orientation, the first and second extensions being configured to resiliently move away from each other when the applied force is released to return the first and second fingers toward the engaged orientation;
the first and second fingers, in the engaged orientation, defining a first clearance therebetween to secure the support member within the support-body opening; and
the first and second fingers, in the released orientation, defining a second clearance therebetween, larger than the first clearance, to release the support member to be withdrawn from the support-body opening.

2. The clip of claim 1, for use with the support member extending between the first stud with the second stud, the first stud having a first stud opening and the second stud having a second stud opening, the clip further comprising:
a stud-attachment portion that includes a first arm and a second arm, the first and second arms being configured to collectively secure the clip to either of the first or second studs at the first or second stud openings;
wherein the support body is integrally formed with the stud-attachment portion.

3. The clip of claim 2, wherein the support body is connected to the stud-attachment portion with a neck that angles away from a vertical plane defined by the first or second stud when the support body is secured to the first or second stud.

4. The clip of claim 1, wherein the first and second extensions are formed as first and second ears extending from the first and second opposing sides of the support-body opening, away from the first and second fingers, respectively.

5. The clip of claim 1, wherein the first and second extensions are configured to be manually squeezed together to move the first and second fingers to the released orientation.

6. The clip of claim 1, wherein a third clearance between third and fourth opposing sides of the support-body opening is larger than the first clearance between the first and second fingers.

7. The clip of claim 1, wherein the support body is formed from spring steel.

8. A support arrangement to secure a support member between a first stud and a second stud, the support arrangement comprising:
first and second support devices that are substantially identical to each other, each including:
a clip portion that is configured to engage either of the first or second studs; and
a support body that includes:
a support-body opening that is closed on four sides and is configured to receive the support member therethrough;
at least one finger extending into alignment with the support-body opening to resiliently secure the support member within the support-body opening; and
at least one extension that is resiliently movable to move the at least one finger to release the support member;
each of the first and second support devices being configured to receive and secure a respective end of the support member via the support-body opening and the at least one finger, and to be clipped to a respective one of the first or second studs via the clip portion, to support the support member between the first and second studs.

9. The support arrangement of claim 8, wherein the at least one finger defines a first clearance for the support member when securing the support member within the support-body opening;
wherein the support-body opening defines a second clearance for the support member, oriented transversely to the first clearance, the second clearance being larger than the first clearance to accommodate a range of non-horizontal orientations of the support member.

10. The support arrangement of claim 8, wherein the at least one finger of each support body includes a first finger and a second finger that are configured to be moved resiliently away from each other, via movement of the at least one extension, to release the support member.

11. The support arrangement of claim 10, wherein the at least one extension includes a first extension and a second extension; and
wherein the second extension is resiliently movable towards the first extension to resiliently move the first and second fingers away from each other.

12. The support arrangement of claim 8, with the first or second stud defining a vertical plane, wherein each of the first and second support devices further includes a neck that connects the clip portion to the support body; and
wherein the neck is configured to angle away from the vertical plane, between the clip portion and the support body, when the clip portion is clipped to the first or second stud.

13. The support arrangement of claim 8, wherein an end of the at least one finger that engages the support member includes a cut-out with at least three sides.

14. A support device to support a support member relative to a building structure, the support device comprising:
a support body that includes:
a support-body opening that is sized to receive the support member;
a first finger extending into alignment with the support-body opening to resiliently engage the support member to secure the support member within the support-body opening; and
first and second extensions that are configured to be squeezed toward each other to move the first finger and thereby release the support member to slide within the support-body opening.

15. The support device of claim 14, further comprising:
a second finger extending into alignment with the support-body opening opposite the first finger to resiliently engage the support member opposite the first finger; and
the first and second extensions being configured to be squeezed toward each other to also move the second finger and thereby release the support member to slide within the support-body opening.

16. The support device of claim 14, wherein the support body fully encloses a perimeter of the support-body opening.

17. The support device of claim 14, wherein the first finger extends from a first side of the support-body opening towards a second side of the support-body opening, along third and fourth sides of the support-body opening; and
wherein the first extension and second extensions are configured to flex the support body along the third and fourth sides of the support-body opening upon being squeezed toward each other, to move the first finger to release the support member to slide within the support-body opening.

18. The support device of claim 14, wherein the support device is formed as an integral spring steel stamping.

19. The support device of claim 14, the support device further comprising:
an attachment portion that is configured to secure the support device to the building structure; and
a neck that extends between the attachment portion and the support body;
wherein the attachment portion defines a plane corresponding to a vertical plane of the building structure and the neck angles away from the plane.

20. The support device of claim 14, wherein the first finger extends from a first side of the support-body opening towards a second side of the support-body opening, along third and fourth sides of the support-body opening;
wherein the first finger at least partly defines a first clearance for the support member, to secure the support member within the support-body opening; and
wherein the third and fourth sides of the support-body opening define a second clearance for the support member that is larger than the first clearance.
